(19) United States
(12) Patent Application Publication
(10) Pub. No.: US 2004/0252370 A1
(43) Pub. Date: Dec. 16, 2004

(54) Optical microscope able to operate a rapid three dimensional modulation of the position of the observation point

(76) Inventors: Mario Ettore Giardini, Cava Manara (IT); Mario Vittorio Corti, Segrate (IT); Stephen Charles Lauder Botcherby, Surrey (GB)

Correspondence Address: SUGHRUE MION, PLLC, 2100 PENNSYLVANIA AVENUE, N.W., SUITE 800, WASHINGTON, DC, 20037, US

(21) Appl. No.: 10/493,972

(22) PCT Filed: Jul. 8, 2003
(86) PCT No.: PCT/EP03/07315

(30) Foreign Application Priority Data
Jul. 10, 2002 (IT) TO2002 A 000602

(51) Int. Cl. G02B 21/00

(52) U.S. Cl. 359/368

(57) ABSTRACT

An optical microscope is described for observation of a specimen (10) capable of diffusing or emitting a beam of light, which includes a main optical system for formation of a real or virtual image of an area of observation of the specimen (10), comprising a main optical path from an objective (20) towards a real image plane or, respectively, towards a direction of observation of a virtual image, along which are interposed one or more movable beam diverting mirrors (28) operable to direct the image of a selected area of the observation plane of the specimen (10) towards the said real image plane or the said observation direction. The microscope includes an additional optical system (30) interposed along the optical path, operable to modulate the position of the area of observation of the specimen (10) along the optical axis, the image of which is formed or observed at focus. In its preferred embodiment this system (30) includes an optical beam divider (40) operable to divert the beam from the main optical path towards a supplementary branch of the path, and a catadioptric system (44, 46) of variable configuration operable to modulate the length of the supplementary path; the divider (40) also being arranged for reintroduction of the modulated beam into the main path.

The present invention relates to an optical microscope for observation of a specimen, both through an eyepiece and for use in a confocal configuration, as defined in the preamble of Claim 1.

In the observation of a specimen, for example for research in the cellular biology field, in which it is necessary to be able to focus the image on different observation planes and/or to track a particle or a cell in its free movement in the surrounding environment, it is necessary to have available optical instruments for the formation of images which allow a rapid and precise three dimensional scanning of the field of view.

In microscopes arranged to track a free particle the optical system of the microscope must be able to maintain the particle in focus while following its every movement.

Achieving these objectives by using conic scanning techniques of an observation plane, together with traditional autofocus techniques for which movement of the objective unit of the microscope or the specimen slide takes place along the optical axis as described for example in U.S. Pat. No. 5,483,055 and U.S. Pat. No. 4,000,417, does not allow three dimensional tracking to be effected by adjusting the focusing means in times shorter than 20 ms to is because of the inertia of the objective unit or the specimen slide.

This applies both to traditional microscopes for direct viewing by an operator through an eyepiece system, and to confocal microscopes, in which the scanning of a confocal aperture conjugate to an observation object point allows the formation of a point-by-point image with better contrast and resolution.

In the prior art observation with three dimensional tracking of a particle can also be obtained by constructing the volumetric image of the specimen by superimposition of images detected through a two dimensional scanning of a succession of focal planes of observation. The axial scanning takes place by moving the objective of the microscope by means of an actuator, and a calculator determines the position of the particle under observation after having acquired several images in different planes. Technical solutions of this type are described in U.S. Pat. No. 5,932,872 and in the article “3D Particle Tracking on the Two-Photon Microscope” by di T. Ragan, P. T. So, H. Kwon and E. Gratton appearing in the proceedings of SPIE Vol. 4262, for 2001.

The object of the present invention is to provide an optical microscope for observation on an arbitrary surface and three dimensional tracking of particles, which allows a rapid modulation of the position of the focus along a direction parallel to the optical axis together with scanning in an observation plane orthogonal to this axis, avoiding the disadvantages of the prior art.

According to the present invention this object is achieved by an optical microscope having the characteristics set out in Claim 1.

Particular embodiments of the invention are defined in the dependent claims.

In summary the present invention is based on the principle of modifying the optical path of a light beam collected by the objective and directed towards a real image plane (in a confocal microscope) or an observation direction (for a traditional microscope) by introducing, downstream of the objective, an additional optical system which makes it possible to modulate the focal plane of the instrument without intervening in the movement of the objective unit or the specimen-carrier slide.

This system forms a supplementary optical path which comprises, in the preferred embodiment, a lens and a mirror disposed close to the focus of the lens, the mutual spacing of which along the optical axis of the system can be modified in such a way as to vary the observation plane of the specimen focussed on the image plane.

In a general optical definition which we will adopt in the following description, a system including both refracting surfaces and reflecting surfaces will be called a catadioptric system.

In an alternative embodiment the supplementary optical path comprises only mirrors, and in this case we will adopt for conformity the denomination of catoptric system.

A variant of the supplementary path, applicable both to the catadioptric systems and the catoptric system, provides for interposition of a pair of rotatable prisms between the elements of the system, which are thus maintained fixed.

Advantageously the architecture of the microscope according to the invention allows it to be formed as a traditional microscope for tracking free particles by means of conic scanning on three axes, by improving the known conic scanning system on two axes, as well as a confocal microscope for the detection of images on an arbitrary observation surface and possible tracking by three dimensional conic scanning.

Further characteristics and advantages of the invention will be explained in more detail in the following detailed description given by way of non-limitative example with reference to the attached drawings, in which:

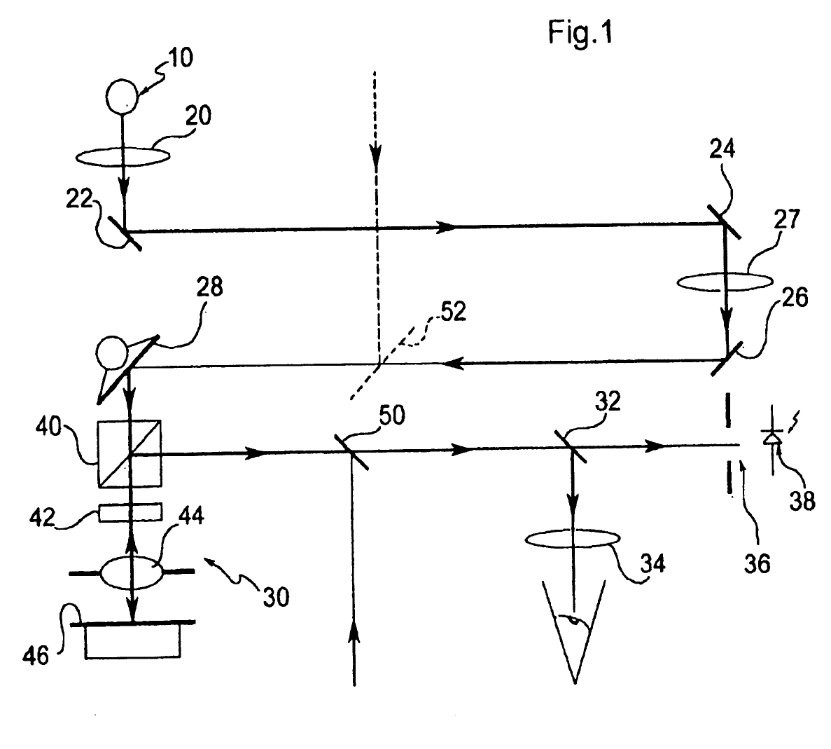

FIG. 1 is a schematic representation of a preferred embodiment of the complete optical system of a microscope according to the invention;

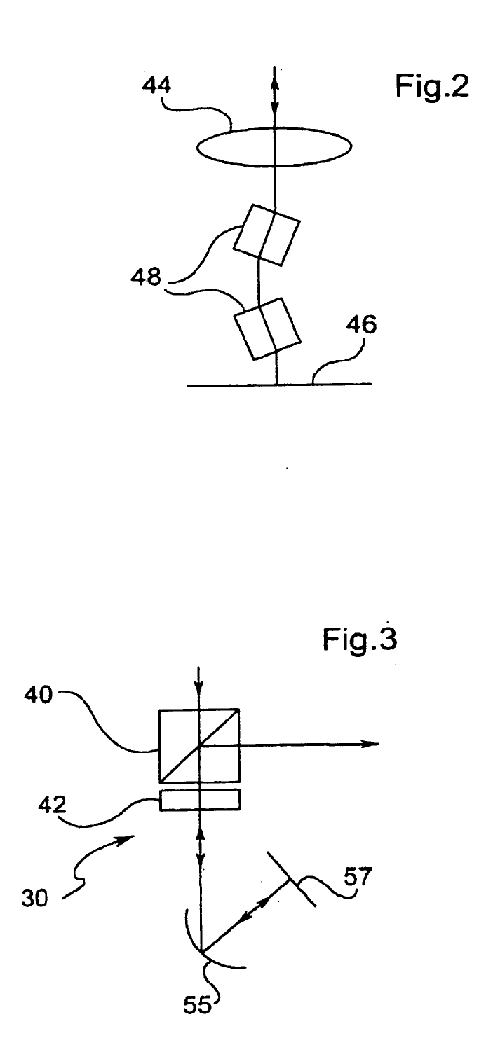

FIG. 2 is a schematic representation of a portion of the optical system illustrated in FIG. 1, according to a variant embodiment; and

FIG. 3 is a schematic representation of a portion of the optical system illustrated, in an alternative embodiment.

In the schematic illustration of FIG. 1 an object, or more generally a specimen under observation, is indicated 10, for example illuminated by light radiation coming from a source outside the microscope and capable of diffusing incident light radiation or emitting radiation itself by fluorescence.

The optical system of the microscope comprises an objective 20, here symbolically identified as a simple lens, disposed close to the specimen 10 to collect light diffused by or emitted from it and to form a collimated or focused light beam.

The optical path of the instrument in its initial section comprises a series of fixed mirrors 22, 24, 26 for deflecting the light beam, used to fold the beam for the purpose of reducing the size of the instrument, and a field lens 27 for determination of the field of view of the image of the object under observation.

A movable mirror, indicated 28, is tiltable about two orthogonal axes by means of a piezoelectric positioner, and is operable to produce an angular deviation of the beam. This function can be performed similarly by a pair of movable mirrors, each tiltable about a single axis, or by a movable lens.

An additional optical system 30 operable to modulate the position of the specimen observation area along the optical axis is interposed in the optical path in such a way as to insert a supplementary branch of the light path.

A beam divider 32 (for example a dichroic mirror) is disposed along the optical path downstream of the system 30 for directing a portion of the beam towards a collection lens 34 (ocular) which permits direct vision through the instrument by an operator and allows the transmission of a portion of the incident beam on a confocal aperture 36 conjugate to the observation area, behind which is disposed a photodetector 38 aligned with the optical axis of the system and operable to detect the instantaneous luminous intensity of the beam.

The additional optical system 30 includes a beam divider, for example a partially reflecting mirror, or preferably a polarising prism 40 as indicated in the drawing, and a quarter wave plate 42 for converting of the polarisation of the beam, a converging lens 44 and a mirror 46 disposed close to the focus of the lens.

In a currently preferred embodiment the positions of the lens 44 and the mirror 46-disposed perpendicularly to the optical axis can vary by translation along this axis. For this purpose the lens 44 is mounted on a piezoelectric positioner and the mirror on a magnetic positioner, or vice versa. Simpler embodiments are however possible, in which only one of the two elements is movable.

In a variant illustrated in detail in FIG. 2, in which both the lens 44 and the mirror 46 are fixed, a pair of rotatable prisms 48 is interposed between the lens and the mirror in order to modify the length of the optical path of the supplementary branch.

A further beam divider 50 (in the most common form a dichroic mirror) is insertable in the optical path to allow illumination of the object 10 along the optical axis, for example by excitation of fluorescence or by capturing a particle by means of optical confinement techniques (optical tweezer). The beam divider 50 is capable of receiving a beam of illumination from an associated light source, not shown, and is able to reflect this beam along the optical axis of the system towards the objective, whilst also permitting transmission of the beam coming from the object 10, and collected by the objective, towards the real image plane or, respectively, the observation direction.

A mirror 52 possibly insertable downstream of the objective 20 and of the image collector and deflector optics (elements 22, 24, 26, 27) excludes these elements thereby permitting the microscope to be coupled to external image optics, for example an auxiliary port of an inverted microscope.

In an alternative embodiment illustrated in FIG. 3, the additional optical system 30 comprises a converging mirror 55 and a plane mirror 57 disposed close to the focus of the converging mirror, translatable along the optical axis. A man skilled in the art will easily be able to put the invention into practice in the mirror-only configuration by likewise applying the constructional variant of FIG. 2, interposing a pair of rotatable prisms between the mirrors to modify the length of the optical path of the supplementary branch without recourse to movement of the mirror 57.

The operation of the traditional image collection and beam bending part of the microscope described is well known to those skilled in the art and will therefore not be described in detail here.

The field lens 27, disposed in the image plane of the objective, forms an image of the pupil of the objective 20 on the movable mirror 28 and an observation area (field of view) is selected by the position assumed by the mirror 28 the variable orientation of which allows exploration of the observation plane orthogonal to the optical axis.

The assembly formed by the confocal aperture 36 and the photodetector 38 allows observation of the object 10 in the confocal configuration and the formation of a map of the intensity distribution in the observation plane upon variation in the inclination of the mirror 28.

The additional optical system 30 forming the subject of the invention allows translation of the observation point confocally conjugate with the aperture 36 in a direction parallel to the optical axis to be controlled.

In detail, the beam divider 40 intercepts the beam deflected by the mirror 28 and directs it towards the supplementary path comprising of the elements 42, 46.

The light beam traverses the polarising prism 40 and emerges with linear polarisation, the orthogonal polarisation component being lost by reflection, and the quarter wave plate 42 provides for conversion of the linear polarisation into circular polarisation. After reflection at the mirror 46, which causes an inversion of the sense of rotation of the circular polarisation, this is then converted back into linear polarisation when the beam again traverses the plate 42. Finally, the divider prism 40 reflects the entirety of the incident polarised beam emitting it along the main path towards the real image plane defined by the confocal aperture 36 or, respectively, the observation direction of the virtual image formed by the collection lens 34.

Various non-exhaustive examples of applications for which the microscope forming the subject of the invention is intended to be used include tracking of particles and/or free cells in liquids, the formation of images with confocal techniques for exploration of specimens on arbitrary surfaces, tracking and contemporaneous excitation of spatially selective fluorescence, tracking and intrinsically coaligned optical trapping of particles in liquids.

In applications for tracking of free particles by means of conic scanning techniques the position of the movable elements 28, 44, 46 (or 28, 55, 57) is varied in such a manner as to conjugate the position of the object observation point to the confocal aperture 36.

The actuators for the movable elements are arranged to regulate the orientation of the mirror 28 and to vary the spatial configuration of the system lens 44-mirror 46 (or convergent mirror 55-plane mirror 57) in a first operating mode, in such a way as to cause an alternating displacement (not necessarily periodic) of the area and of the observation plane about an observation point thus realising a three dimensional conic scanning. They are, moreover, arranged to regulate the orientation of the mirror 28 and vary the spatial configuration of the system comprising the lens 44 and mirror 46 (or convergent mirror 55-plane mirror 57) in a second operating mode, in such a way as to perform a corrective displacement of the area and the plane of observation as a function of the detected luminous intensity distribution signal emitted by the photodetector 38 to perform three dimensional tracking of the particle under observation.

Translation of the observation point confocally conjugate with the aperture 36 along a direction parallel to the optical axis, that is to say focussing on a different observation plane of the object 10, is obtained by varying the relative position between the lens 44 and the mirror 46 (or between converging mirror 55 and plane mirror 57) or, in the embodiment of FIG. 2, by concordant rotation of the pair of prisms 48, in such a way as to vary the length of the optical path between lens and mirror (between mirrors respectively).

The position of the observation point (field of view) is modulated along the optical axis of the system (generally indicated Z axis) and over a pair of axes of an observation plane orthogonal to it (generally indicated X and Y) by controlling the movement of the mirror 28 and the catadioptric system formed by the lens 44 and the mirror 46 (or the catoptric system formed by the converging mirror 55 and plane mirror 57) through associated actuators (not shown).

If the modulation is periodic according to a sinusoidal law at a frequency f, by symmetry of the system the intensity of the light collected by the photodetector 38 varies at a frequency 2f, equal to twice the frequency of modulation. If, for example, the object under observation is displaced along a modulation axis, a component appears in the signal detected at the modulation frequency f the phase of which provides the sign of the displacement.

By detecting the signal synchronously with respect to the modulation signal an analogue signal proportional to the correction needed to impart to the movable elements 28, 44, 46 (or 28, 55, 57) to realign the observation point to the object is therefore obtained from the photodetector 38.

With respect to the entirely or partially digital solutions, the entirely analogue processing of the signal detected and the control signal of the actuators advantageously allows tracking to be achieved in very short times since it is not necessary for the A/D conversion time, the calculation time and/or the D/A conversion time to elapse, and greater precision is obtained by not having the intervention of quantisation noise on the determination of the position of the object point. There are thus three analogue signals available which are proportional to the position of the object on the three axes X Y and Z respectively.

By separating the signals relating to the three axes in frequency and/or phase (for example by modulating the position of the observation point on the plane orthogonal to the optical axis in quadrature at the same frequency, so that circumferential exploration of the plane is obtained, and by modulating the position of the observation point along the optical axis at a different frequency) it is possible to effect tracking of the object contemporaneously along the three axes.

In applications for exploration of a specimen on an arbitrary surface, the position of the movable elements 28, 44, 46 (or 28, 55, 57) is regulated in such a way as to conjugate with the confocal aperture 36 an observation object point the position of which in space varies according to a predetermined rule.

The actuators for the movable elements are therefore arranged to regulate the orientation of the mirror 28 and to vary the spatial configuration of the lens system 44—mirror 46 (or convergent mirror 55—plane mirror 57) in a third operating mode, in such a way as to cause three-dimensional displacement of the observation point on a curve (path) belonging to the predetermined observation surface.

The images of a plurality of observation points collected from photodetector 38 are transmitted to an associated processing unit (not shown) for reconstruction of a complete image according to known techniques.

Naturally, the principle of the invention remaining the same, the embodiments and details of construction can be widely varied with respect to what has been described and illustrated purely by way of non-limitative example, without by this departing from the scope of protection defined in the annexed claims.

In particular, other supplementary branches could be added to the system, comprising an additional optical system as described, downstream thereof, to superimpose other regulations along the optical axis.

1. An optical microscope for observation of a specimen (10) capable of diffusing or emitting a beam of light rays, including a main optical system for the formation of a real or virtual image of an area of observation of the specimen (10), comprising a main optical path from an objective (20) towards a real image plane or, respectively, towards the observation direction of a virtual image, along which are interposed movable beam diverter means (28), operable to direct images of a selected area of the observation plane of the specimen (10) towards the said real image plane or the said observation direction,
characterised in that it includes an additional optical system (30) interposed along the said optical path, operable to modulate the position of the area of observation of the specimen (10) along the optical axis, the image of which is formed or observed at focus, the said system including:
optical beam divider means (40) operable to divert the said beam from the main optical path towards a supplementary branch of the path; and
an optical system (44, 46; 55, 57) of variable configuration operable to modulate the length of the supplementary path,
the said divider means (40) being operable to reintroduce the beam emerging from the said variable configuration system (44, 46; 55, 57) into the said main path towards the real image plane or, respectively, the observation direction of the virtual image,
the microscope including actuator means operable to move the said beam diverter means (28) and the said variable configuration system (44, 46; 55, 57) in predetermined manner.

2. A microscope according to claim 1, characterised in that it includes photodetector means (38) disposed close to the real image plane of the main optical system and aligned with the optical axis of the system, for instantaneous detection of the luminous intensity of the beam,
and in that the said actuator means are arranged to regulate the orientation of the said beam diverter means (28) and to vary the spatial configuration of the variable configuration system (44, 46; 55, 57) in a first operating mode, in such a way as to cause an alternating displacement of the area and plane of observation about an observation point thus achieving a three dimensional scanning.

3. A microscope according to claim 2, characterised in that the actuator means are further arranged to regulate the orientation of the said beam diverter means (28) and to vary the spatial configuration of the variable configuration system (44, 46; 55, 57) in a second operating mode, in such a way as to perform a corrective displacement of the area and observation plane as a function of the signal emitted by the said photodetector means (38) to perform three dimensional tracking of an object under observation.

4. A microscope according to claim 1, characterised in that it includes a confocal aperture (36) conjugate with an observation point, operable to allow transmission of a portion of the light beam towards photodetector means (38) disposed downstream of the said aperture (36) and aligned with the optical axis of the system,
and in that the actuator means are arranged to regulate the orientation of the said beam diverter means (28) and to vary the spatial configuration of the variable configuration system (44, 46; 55, 57) in a third operating mode in such a way as to cause a three dimensional displacement of the observation point in a predetermined observation path,
the images of a plurality of observation points collected by the said photodetector means (38) being transmitted to associated processor means for reconstruction of a complete image.

5. A microscope according to claim 1, characterised in that the said variable configuration system is a catadioptric system comprising a converging lens (44) and a mirror (46) disposed perpendicularly of the optical axis, the mirror (46) being positioned close to the focus of the lens (44).

6. A microscope according to claim 1, characterised in that the said variable configuration system is a catoptric system comprising a first converging mirror (55) and a second plane mirror (57), the plane mirror (57) being positioned close to the focus of the converging mirror (55).

7. A microscope according to claim 5, characterised in that in the said beam divider means comprise a polarising prism (40).

8. A microscope according to claim 5, characterised in that the said beam divider means comprise a dichroic mirror.

9. A microscope according to claim 5, characterised in that the said beam divider means comprise a partially reflecting mirror.

10. A microscope according to claim 5, characterised in that the said additional optical systems (30) further includes a quarter wave plate (42) interposed between the said beam divider means (40) and the said variable configuration system (44, 46; 55, 57) operable to perform a conversion of the polarisation of the incident beam.

11. A microscope according to claim 5, characterised in that the said actuator means are operable to vary the relative distance between the lens (44) and mirror (46).

12. A microscope according to claim 11, characterised in that the said actuator means comprise a magnetic or piezoelectric positioner operable to cause translation of the lens (44) along the optical axis.

13. A microscope according to claim 11, characterised in that the said actuator means comprise a magnetic or piezoelectric positioner operable to cause translation of the mirror (46) along the optical axis.

14. A microscope according to claim 6, characterised in that the said actuator means comprise a magnetic or piezoelectric positioner operable to cause translation of the plane mirror (57) along the optical axis so as to vary the distance thereof from the converging mirror (55).

15. A microscope according to claim 5, characterised in that the catadioptric system comprise a pair of rotatable prisms (48) interposed between the lens (44) and mirror (46).

16. A microscope according to claim 6, characterised in that the catoptric system comprises a pair of rotatable prisms (48) interposed between the converging mirror (55) and the plane mirror (57).

17. A microscope according to claim 15, characterised in that the said actuator means are arranged to command rotation of the said pair of prisms (48) by virtue of which the length of the supplementary branch of the optical path is varied.

18. A microscope according to claim 1, in which the said movable beam diverter comprise a movable mirror (28) capable of rotating about two orthogonal axes.

19. A microscope according to claim 1, in which the said beam diverter means include a pair of independent movable mirrors capable of rotating about respective orthogonal axes.

20. A microscope according to claim 18, in which each movable mirror is moved by a respective piezoelectric or magnetic positioner.

21. A microscope according to claim 1, including an ocular optical system (32, 34) for observation by an operator.

22. A microscope according to claim 1, including means for coaxial illumination of the sample, which include a source of illumination and beam divider means (50) in the optical path and capable of receiving a beam of light from the source, the said beam divider means (50) being operable to reflect the light beam along the optical axis of the system towards the objective (20) and to permit transmission towards the real image plane or, respectively, the direction of observation of the light beam collected by the objective (20).

23. A microscope according to claim 1, including a reflecting element (52) insertable between the objective (20) and the said beam diverter means (28), for coupling the microscope to external imaging optics and exclusion of the beam collected by the objective (20).
